(19) United States
(12) Patent Application Publication
(10) Pub. No.: US 2013/0206023 A1
(43) Pub. Date: Aug. 15, 2013

(54) METHOD AND APPARATUS FOR FORMING AN ARTICLE FROM PULPED MATERIAL

(71) Applicant: Martin Myerscough, Suffolk (GB)

(72) Inventor: Martin Myerscough, Suffolk (GB)

(73) Assignee: GREENBOTTLE LIMITED, Esher (GB)

(21) Appl. No.: 13/703,731

(22) PCT Filed: Jun. 17, 2011
(86) PCT No.: PCT/GB11/00917

§ 371 Date: Feb. 7, 2013

(30) Foreign Application Priority Data
Jun. 18, 2010 (GB) 1010307.5

(51) Int. Cl. B30B 5/02

(52) U.S. Cl. CPC B30B 5/02
USPC 100/211

(57) ABSTRACT

Press tool for pressing liquid from an article, for example a pulp article formed by a pulp moulding process. The tool includes a flexible mould surface (170) and a source of fluid arranged such that the source of fluid can be selectively supplied behind the mould surface (170) causing deformation of the flexible mould surface (170) and the consequent application of pressure to the article.

### FIELD OF THE INVENTION

The present invention relates to a method and apparatus for use in the manufacture of articles moulded from a pulp material, for example wood or paper pulp. In particular the invention relates to a method and apparatus for drying an article moulded from a porous material.

### BACKGROUND

It is known to manufacture articles by moulding pulp material, for example egg boxes moulded from paper pulp.

The pulp material typically comprises about 1% paper and 99% water initially, allowing the pulp material to be pumped.

The pulp material is formed on a mould tool. For example, a male or female tool is dipped into a vat of the pulp material to coat the tool. A vacuum or suction force is applied to suck and retain the pulp material onto the tool. In doing so, some water is sucked from the material on the mesh tool, creating a felt having a water content of about 80%. If the water content of the article is greater than 80%, the article does not have sufficient rigidity to allow this to be removed from the mould tool.

The majority of the remaining water must then be removed from the article. In removing the remaining water, it is desirable to ensure the dimensional accuracy of the final product, allowing articles to be formed with a consistent size and shape. Energy will be required to remove the remaining water. However, energy is an expense in the manufacturing process, and therefore it would be desirable to use the minimum amount of energy, and to use less costly energy where possible. It is also desirable to produce the products quickly. Where it is required to produce products at a certain rate, reducing the time required to produce each individual article can reduce the number of lines or tools required to produce the articles and can therefore reduce the initial cost of providing the lines or tools, and the ongoing maintenance costs. Further, producing products at a higher rate will itself reduce the energy requirements since there will be less time for energy loss. It is therefore desirable to produce articles accurately and with minimal energy costs at a high rate to reduce overall manufacture costs.

In some known systems, the felt is removed from the mould tool and is dried off tool, for example in an oven. The oven may be a gas heated or microwave oven, or may be an oven in which superheated steam is directed over the surface of the articles in an impingement drying process. Superheated steam has been found to dry the articles more efficiently than hot gas due to the better heat transfer characteristics. Microwave ovens are available having power of up to 100 kW which can evaporate the water in the article rapidly. In any case, water will be removed from the article in the oven, for example reducing the water content in the article to around 10% or less. The resulting article may be subject to a finishing process, for example a final pressing step. This can improve the final finish of the article, and may remove some of the remaining water content.

With such drying methods, it can be difficult to obtain high dimensional consistency and stability of the products, especially between batches of products. This believed to be due to parts drying at different speeds causing distortion. Further, the energy required to dry the product in the oven is high, resulting in a high cost for production of the article.

It is also known to dry moulded products by hot pressing. This has the advantage that the articles can be formed with greater dimensional accuracy and consistency, and can have greater strength as the article is shrunk onto the mould during the drying process. In this case it is normal to transfer the felt from the mould tool to a heated tool having a similar profile as the article, and then pressing the article using the heated tool. The application of heat to the article causes water in the article to evaporate and thereby dry the article. Typical temperatures are in excess of 250° C. The application of pressure increases the heat transfer by conduction between the tool and the article and therefore improves the drying of the article. Pressures can be in excess of 3×10⁵ Pa. The mould tool is typically a mesh or sintered tool, allowing water to pass through the mould tool during the drying of the article. As with off tool drying, the known on tool drying requires a lot of energy and is slow.

For efficient sucking of the pulp material onto the mould tool and for the removal of water from the article through a tool, the tool is often formed from a porous material and/or one including through paths through which fluid can pass. Especially where the quality of the pulp material is not known or is not consistent, for example where the pulp material is recycled material, the pulp material may include impurities or contaminants such as ink. Such impurities or contaminants may be removed with water from the article, and may block openings in the tools, which can prevent water from being removed efficiently. It is therefore known to form the mould tool and any subsequent tools as mesh tools, being formed as an open or closed mesh structure providing large passageways for fluid flow which are unlikely to be blocked by impurities or contaminants. Other known tools include sintered tools, including sintered ceramic and sintered bronze tools, as well as perforated tools, such as perforated aluminium tools. Such tools are commonly formed with clusters of smaller holes, each cluster being separated from the other by about 2 cm.

### SUMMARY OF THE INVENTION

According to the present invention, there is provided a press tool comprising a flexible mould surface and a source of fluid arranged such that the source of fluid can be selectively supplied behind the mould surface causing deformation of the flexible mould surface and the consequent application of pressure.

The gradual application of pressure across the article when pressed using the press tool of the present invention can act to squeeze moisture out of the article more efficiently than by application of a uniform pressure across the entire article. Such a gradual application of pressure is achieved by providing the mould tool with a flexible mould surface and applying a fluid behind the mould surface causing application of pressure, the fluid gradually spreading behind and across the flexible mould surface to expand the area of applied pressure. In this way, the pressure is applied normal to the surface of the article, even on portions of the article which are not flat. Further, the hydraulic wave improves the efficiency of the water extraction.

The flexible mould surface may be formed of a liquid impermeable membrane. For example, the mould surface may be rubber based and mouldable, or may be of a plastics material. The flexible mould surface may be formed over a solid backing member, with the fluid being injected into the space between the flexible surface and the backing member. The material of the flexible surface and the fluid should be selected to give the desired application of pressure and spread of pressure. The flexible surface may be formed from a sheet of material, that may be folded or formed around a planar or other tool surface, or may have a non-planar shape, for example being moulded with a desired three-dimensional surface, for example conforming to the shape of the article being produced.

The fluid may be injected into the space between the flexible surface and the backing member through a single opening, or through a number of openings. The injection of fluid through a number of openings may be particularly beneficial when the article has a complex shape, since different openings may be associated with different parts of the shape, to ensure that the moisture is directed away from the article in a desired direction. However, multiple openings may be used even when the article has a simple shape.

The thickness of the flexible surface could be less than 5 mm and a pressure of between about 5×10⁵ Pa and about 20×10⁵ Pa, for example about 10×10⁵ Pa could be applied. The rate of propogation of the force can be very high, preferably between 30 and 40 metres per second, for example up to about 33 metres per second.

In accordance with a further aspect of the invention, there is provided a method of pressing using a pressing tool that applies a pressure that extends laterally.

The method can be implemented using the press tool of the first aspect of the invention.

The press tool and associated method of the present invention may be used in the formation of an article by moulding a pulp material which includes the steps of
moulding the article on the surface a mould tool;
pressing the moulded article; and,
passing heated gas or superheated steam through the pressed article whilst the pressed article is retained on a tool.

The step of pressing the initially moulded article, which may have a water content of up to about 80%, has been found to be a quick and relatively energy efficient way to remove a significant amount of water from the article. After pressing, the article preferably has a water content of below around 50%. Removal of water before drying with heated gas or superheated steam reduces the amount of energy required to dry and reduces the time required for drying.

Passing heated gas or superheated steam through the pressed article is more energy efficient than conventional drying methods such as on tool heating, or off tool drying in a gas oven, microwave oven or using impingement drying with superheated steam. Furthermore, by drying on tool, greater dimensional accuracy and consistency is achieved, as well as improved strength and structural properties of the article. This is believed to be due to the article being dried and compacted onto a tool surface and an element of pretensioning. Passing heated gas or superheated steam through the material gives very good and quick heat transfer.

It is also considered that the drying of articles by passing heated gas or superheated steam through the product may give the article improved structural properties compared to articles that are dried in other ways. Further, the use of heated gas or superheated steam to remove water from the articles can help avoid burning or scorching of the articles which can occur using other drying methods, which can result in the discolouration of the articles.

Advantageously, following treatment using heated gas or superheated steam, the article will have a water content of less than about 20%.

Following the treatment of the article using heated gas or superheated steam, the article can be subjected to at least one further treatment step to finish the article and/or to remove additional water from the article. One advantageous additional step is to subject the article to microwave energy. In this case, the article may be removed from the tool and subjected to the microwave energy in an off tool state, or may be retained on a tool and subjected to the microwave energy. Exposing the article to microwave energy whilst retained on a tool can be advantageous as this may give a better finish, better dimensional accuracy and/or consistency and/or structural properties for the reasons outlined above. Microwave energy may be able to remove water trapped intra the wood cells because the heat is transmitted directly to the water and not to the wood fibres first.

Where the article is treated with microwave energy, it is preferred that the microwave energy source has an output of at least 20 kW, more preferably up to 100 kW. The microwave energy is advantageously applied to the article for between about 3 and 4 seconds.

Superheated steam may be preferred to heated gas in some aspects as superheated steam has a greater capacity to remove moisture. Superheated steam has better heat transfer characteristics than gas, is denser than air and therefore less volume needs to be pumped through the material to achieve the same heat extraction and is inherently at a higher pressure.

It is preferred that the superheated steam is heated to a temperature of up to 350° C. The superheated steam is preferably passed through the article for up to around 6 seconds.

It is advantageous to recycle the water removed from the article during any or all of the stages in the formation of the article by returning this water to the pulp material used for the formation of subsequent articles.

The tool or tools may be formed as a mesh tool, sintered tool, such as a sintered ceramic or bronze tool, or as a perforated tool, for example a perforated aluminium tool. A mesh tool is advantageous as it has openings through which fluid can pass, and therefore allows superheated steam to pass easily though the tools to the article and also allows water evaporated or otherwise released from the article to be removed, especially where the water flow is high. Also, the large openings help avoid the holes being blocked by contaminants in the pulp material, such as ink. When the tool has a flexible surface, such as a three dimensional surface that may be moulded or a sheet to give the laterally extending application of pressure, the suction side of the pressing tool would be mesh. Where the tool is to support the article whilst microwaves are applied to the article, it is preferred that the tool is formed of a ceramic or other non-metalic material to avoid interference with the microwave energy.

In an alternative to drying on the tool with heated gas or superheated steam, the article may be dried by subjecting the pressed article to microwave energy whilst the pressed article is retained on a tool. The article may alternatively be dried off tool by any known or suitable method.

### BRIEF DESCRIPTION OF THE DRAWINGS

FIG. 1 shows a flow chart of a method of forming an article by pulp moulding;

FIG. 2 shows a series of manufacturing stations for performing the method as shown in FIG. 1;

FIG. 3 shows a view of a pressing station for pressing the article in accordance with the present invention;

FIG. 4 shows a flow chart of an alternative method of forming an article; and,

FIG. 5 shows a flow chart of an alternative method of forming an article.

### DETAILED DESCRIPTION OF PREFERRED EMBODIMENTS

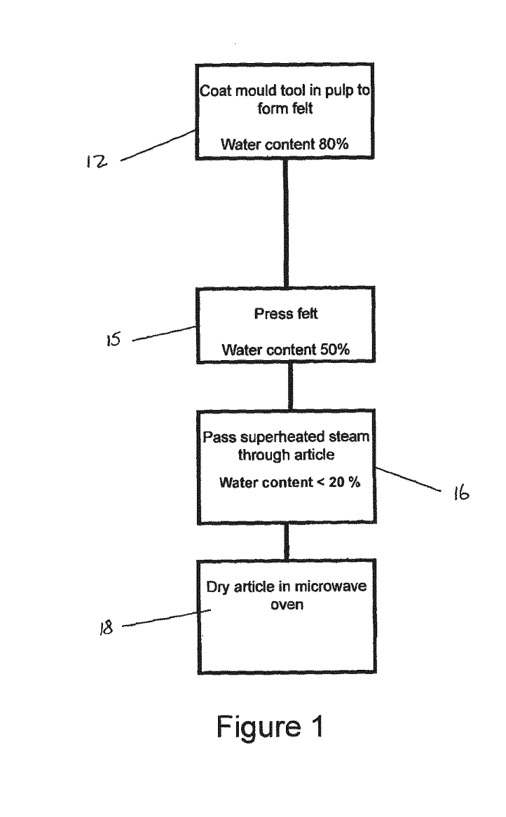

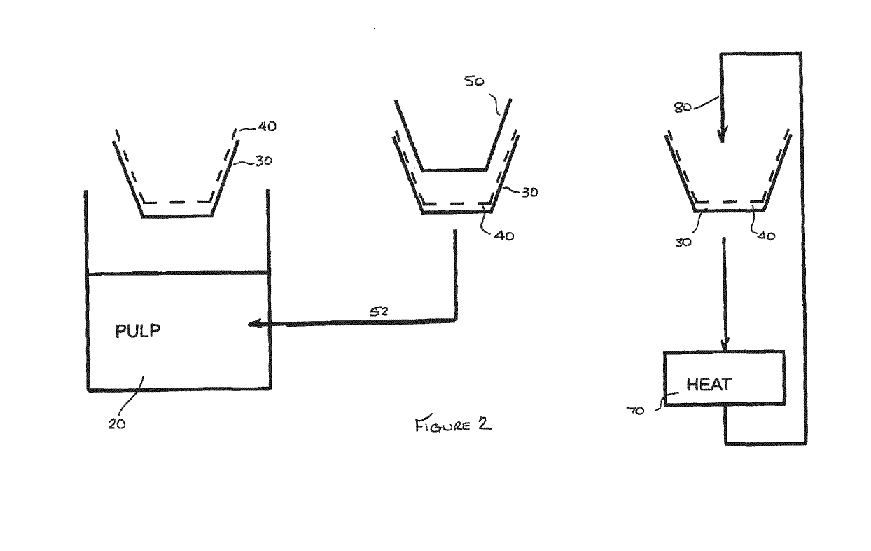

As shown in FIG. 1, in one example of the formation of an article by moulding, the article is first moulded (12), is pressed to reduce the water content (15), and then treated with superheated steam (16) whilst on a tool to further dry the article. The article may then be further dried, for example using on tool or off tool microwaves (18).

The initial moulding step (12) may be a conventional moulding step in which pulp material, typically having a water content of about 99%, may be applied to a mould tool, such as a mesh tool, and then sucked onto the surface of the mould tool to form a felt having the shape of the article. The pulp material may be provided in a vat, with the mould tool being dipped into the vat to coat the mould tool with the pulp material. The application of suction to suck the pulp material onto the mould tool will also remove some of the water from the pulp material, such that the moulded felt has a water content of about 80%. The removed water may be returned to the pulp material in the vat.

The next stage is to press the article. This both compresses the material to densify the article, and squeezes out water. The press tool may be a mesh tool providing an easy path for removal of the water content of the material, although other press tools may be used such as sintered or perforated tools. The application of pressure to the article, for example a pressure of around 9×10⁵ Pa and reduce the water content of the article to around 50%. The removed water may be returned to the pulp material in the vat.

As shown in FIG. 2, a reservoir 20 of pulp material is provided. The pulp material is at a temperature greater than ambient. A mesh tool 30 is dipped into the pulp material 20 to form a felt 40 on the mesh tool 30. The mesh tool 30 may be moved to a pressing station where pressure is applied to the felt 40, squeezing water from the felt 40. The water, which will still be above ambient pressure, is returned along line 52 to the reservoir 20. The mesh tool 30 carrying the felt 40, which now has around 50% water content, is then moved to the drying station where superheated steam 80 is passed through the article, removing water from this. The superheated steam 80 that has passed through the article will still be at a high temperature and is reheated in heater 70 before being available to further dry the article or to dry a subsequent article.

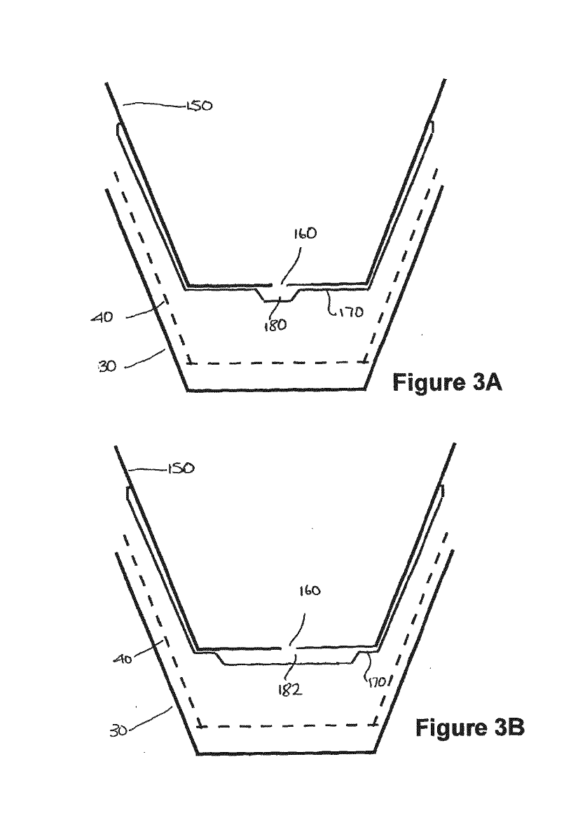

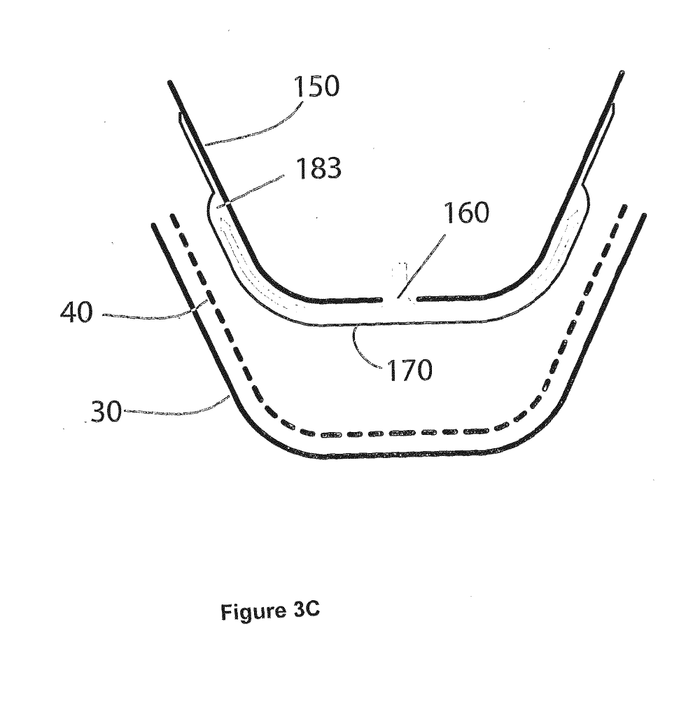

FIGS. 3A to 3C show a press tool according to one example of the present invention arranged to apply an initial pressure at one portion of the article, and progressively move or extend the portion over which pressure is applied laterally, thereby acting to squeeze moisture out. In one example, the mould tool includes a generally solid backing member 150 including one or more openings 160 through which fluid, for example a gas such as air, hydraulic fluid or oil, can be injected. The backing member is covered by a flexible surface such as a sheet 170 sealed around an edge to the backing member 150, such that fluid introduced through the one or more openings 160 in the backing member is received between the backing member 150 and the flexible surface 170. By suitable selection of the viscosity of the fluid and the flexibility of the flexible surface 170, the introduction of fluid will cause an initial deformation of the flexible surface 170 and consequent application of pressure close to the point at which the fluid is introduced. This is shown in FIG. 3A where the initial injection of the fluid is shown to cause the deformation 180 of the central portion of the flexible surface 170. This deformation will cause the application of pressure to the central portion of the felt 40 in a direction normal to the felt 140. As the fluid continues to be introduced, this will flow laterally in the space between the backing member and the flexible surface causing deformation of the flexible surface laterally from the point of introduction of the fluid, as shown as deformation 182 in FIG. 3B. This will result in the gradual and progressive application of pressure laterally across the article, squeezing moisture out. The pressure will be applied normal to the surface of the article, even in non-planar portions of the article, for example in the corners and on the inclined sides. This is shown in FIG. 3C in which the deformation in the flexible surface 170 is shown to extend around the side of the tool and around the corner of the article. After pressing the article, the fluid can be removed from the space between the backing member 150 and flexible surface 170 ready to press the next article.

The pressing method and tools described with respect to FIGS. 3A to 3C can be used in all aspects of the present invention, and in other systems in which pressing is required.

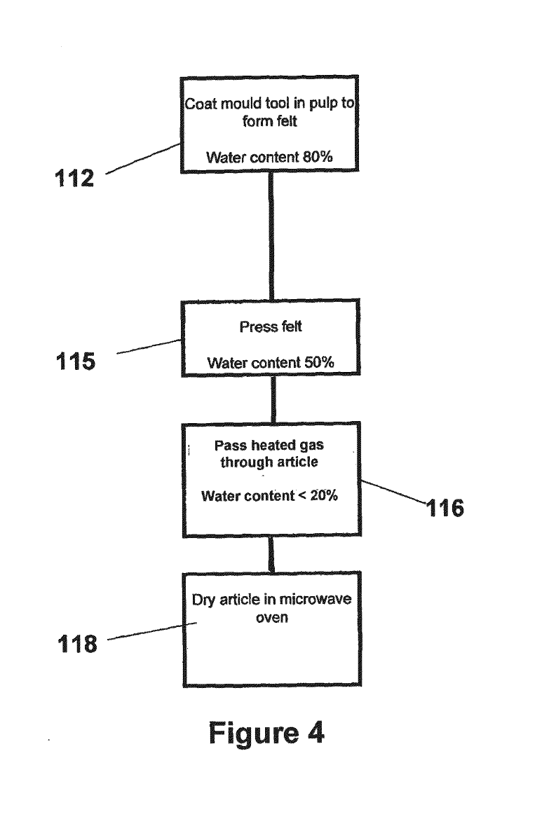

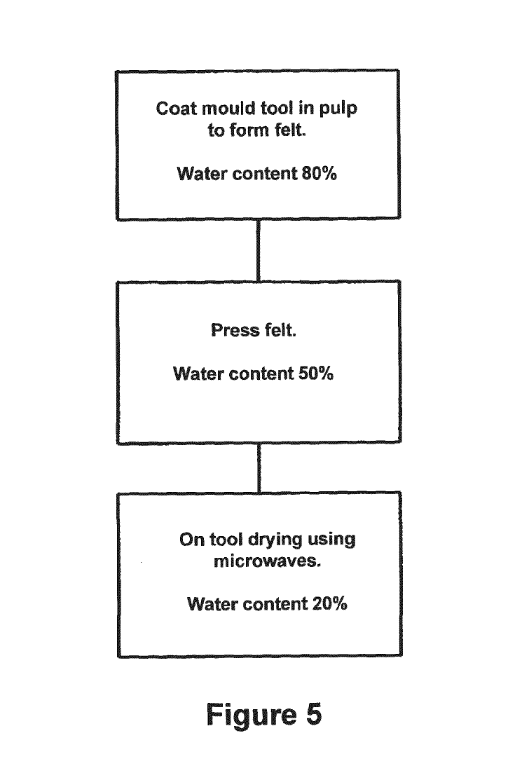

In an alternative example shown in FIG. 4, heated gas is used instead of superheated steam. In this case, the article is moulded (112), pressed to reduce the water content (115), and then treated with heated gas (116) whilst on a tool to further dry the article. The article may then be further dried, for example using on tool or off tool microwaves (118).

The drying using heated gas or superheated steam is carried out while the article is held on a tool. The heated gas or superheated steam is driven through the article held by the tool. The heated gas or superheated steam will absorb water from the article and carry this away in the flow. Although the drying using heated gas or superheated steam can be carried out on the press tool, the article is typically from the press tool to a separate tool for heated gas or superheated steam drying. In either case, pressure is applied to the article using the tool, which may be a mesh tool or on a sintered tool such as a coarse sintered bronze tool or a ceramic tool. Coarse sintered bronze tools typically have pores of 250 μm allowing the water and any removed impurities to be carried by the heated gas or superheated steam flow.

Depending upon the water content in the article, the properties of the heated gas or superheated steam, the flow characteristics through the tool and the article and the like, passing the heated gas or superheated steam through the article for 3 to 4 seconds may be sufficient to dry the article.

The water removed from the article by the heated gas or superheated steam passing through the article may be separated from the steam and returned to the pulp material used for forming further articles. For example, the water may be added to the vat containing the pulp material for mould articles. The remaining fluid can then be reheated to again form heated gas or superheated steam that can be passed through the article or subsequent articles to dry these. In this way, minimum energy is required to process the fluid and form heated gas or superheated steam to continue the process.

The resulting article can then be removed from the tool, and subjected to further treatment if required. For example, the article may be the subject of a further pressing stage, or may be further dried, for example using on tool or off tool microwave drying in which the article is subjected to microwave energy which will act to heat and evaporate any remaining water in the article. The use of microwaves is particularly beneficial as this is able to remove water contained within the fibres of the pulp material as well as water held between the fibres of the pulp material.

Where the article is dried on tool using microwaves, the tool should be a tool that allows water removed from the article to pass through the tool, yet the tool must also allow microwave energy to pass through the tool to the article. Ceramic tools are therefore suitable for this purpose.

The microwave energy should be sufficient to evaporate and remove the water content from the article in an acceptable period of time, for example using microwave energy of at least 20 kW can remove sufficient additional water content in around 3 to 4 seconds.

According to a second example of the invention, the article is moulded and pressed to form an article having a water content of around 50% as described above. However, rather than passing superheated steam through the article to further reduce the water content of the article, the article is subjected to on tool microwave drying. As will be appreciated from the description of the first example, where the article is dried on tool using microwaves, the tool should be a tool that allows water removed from the article to pass through the tool, yet the tool must also allow microwave energy to pass through the tool to the article. Ceramic tools are therefore suitable for this purpose.

The microwave energy should be sufficient to evaporate and remove the water content from the article in an acceptable period of time, for example using microwave energy of at least 20 kW can remove sufficient additional water content in around 3 to 4 seconds.

On tool drying of the article using microwave energy means that the article will contract onto the surface of a tool as the article is dried, and this will help ensure that dimensional consistency and accuracy of the final product, and will also assist in increasing the strength of the final product, for example in comparison to products that are dried off tool.

For forming an article according to either method, it will be appreciated that there are at least three steps in the method—namely the formation of the initial felt by sucking the pulp material onto the mould tool, the pressing of the felt to reduce the water content in the article, and the drying on a tool using either superheated steam or microwave energy. Additional steps may be included in the process, for example additional pressing steps, additional microwave treatment or other finishing. It is convenient for part of the tool holding the article at one station to be movable with the article to the subsequent station to transfer the article to the subsequent station before being moved back to its initial station to carry out the process on the subsequent article.

As noted above, an initially moulded article may have a moisture content of 80%. This means that if the final article is to have a weight of 100 grams (i.e. the 20% of the initially moulded article which is not moisture weighs 100 grams), the initially moulded article has 400 grams of moisture. Removing this amount of moisture using conventional superheated steam or microwave drying would be very costly due to the high energy requirements. By pressing to reduce the moisture content to 50%, the weight of the moisture will equal the weight of the solid parts of the article, i.e. 100 grams. Therefore, reducing the moisture content from 80% to 50% in this example reduces the amount of moisture to be removed during on tool drying from 400 grams to 100 grams. This will therefore require only around a quarter of the energy since there is only a quarter of the amount of moisture to be removed. Therefore, the initial pressing greatly affects the amount of energy required for drying.

Various different articles can be produced in accordance with the methods and apparatus described herein. These include containers such bottles as described in earlier International Patent Application Nos. WO 2007/066090, WO 2009/133355, WO 2009/133359 and WO 2009/153558, as well as egg boxes, trays and bed pans.

1. A press tool comprising a flexible mould surface and a source of fluid arranged such that the source of fluid can be selectively supplied behind the mould surface causing deformation of the flexible mould surface and the consequent application of pressure.

2. The press tool according to claim 1, wherein the flexible mould surface is rubber based.

3. The press tool according to claim 1, wherein the flexible mould surface has a thickness of less than 5 mm.

4. The press tool according to claim 1, in which the pressure applied by deformation of the flexible mould surface is between about 5×10⁵ Pa and about 20×10⁵ Pa.

5. The press tool according to claim 4, in which the pressure applied by deformation of the flexible mould surface is about 10×10⁵ Pa.

6. The press tool according to claim 1, in which a single opening is provided through which the fluid is supplied between the flexible mould surface.

7. The press tool according to claim 1, in which a plurality of openings are provided through which the fluid is supplied between the flexible mould surface.

8. The press tool according to claim 1, in which a rate of propagation of the force is of the order of 30 to 40 metres per second.

9. A method of pressing using a pressing tool that applies a pressure that extends laterally.
